(19) United States
(12) Patent Application Publication
(10) Pub. No.: US 2007/0025802 A1
(43) Pub. Date: Feb. 1, 2007

(54) Dispenser for a product, typically a cosmetic product, with magnetic support

(76) Inventors: Fabrice Dieudonat, Fosses (FR); Marc Phu, Chevilly-Larue (FR)

Correspondence Address: YOUNG & THOMPSON, 745 SOUTH 23RD STREET, 2ND FLOOR, ARLINGTON, VA, 22202, US

(21) Appl. No.: 11/250,491

(22) Filed: Oct. 17, 2005

(30) Foreign Application Priority Data
Oct. 18, 2004 (FR) 04 10993

(51) Int. Cl. B43K 24/02

(52) U.S. Cl. 401/100

(57) ABSTRACT

The dispenser (1) includes a body (2) with a tubular skirt (3), a support (8) for the product (6), a cap (5) and a member for axially displacing the support (8) manually. It is characterised in that: a) it includes a slider (7), able to be displaced manually in an axial run in the axial direction along the tubular skirt (3), the slider (7, 7′, 7″) forming a the first part (70), the support (8) forming or including a the second part (80), the first and second parts (70, 80) being attracted by radial magnetic forces, b) the skirt (3) of the body (2), the slider (7, 7′, 7″), and typically the support, have typically homothetical, noncircular, sections.

### FIELD OF THE INVENTION

The invention relates to the field of stick-form product dispensers, such as lipstick sticks, deodorant sticks, adhesive sticks, etc, or again typically rigid products, which flow under constraint, such as creams, pastes, etc.

### THE PRIOR ART

Many lipstick dispensers or tubes are already known, as described for example in the European applications no. 96500011, 98500016, 98500088, 99420027, and 99420072, that include a body and a cap.

The body of these lipstick tubes typically includes three coaxial parts, with from outside to inside, an outer body forming a skirt of the tube and typically carrying two spiral grooves on its inner surface, a tubular element integral with the bottom of the tube and carrying two diametrically opposite axial orifices, a support for the stick equipped with two diametrically opposite lugs, said lugs passing through said axial orifices and engaging with the spiral grooves, in such a way that the relative rotation of said body relative to said bottom causes an axial displacement of said support and therefore of said stick.

Deodorant dispensers are also known as described for example in French patent no. 2 573 734, or again in European patent no. 0 462 925.

These dispensers typically include a body fitted with a lateral skirt and with a bottom, with a piston forming a support for the deodorant stick, engaging with a central screw which is rotated by an external button forming all or part of said bottom.

### PROBLEMS POSED

The dispensers known in the prior art pose different sorts of problems.

On the one hand, these dispensers constitute assemblies of parts that are relatively complex in themselves, given their number and the precision required to assemble them, and that are, moreover, complex to assemble automatically, with the result that the cost of producing said dispensers is relatively high.

On the other hand, as shown in the case of tubes of lipstick and deodorant dispensers, mechanisms for the manual propulsion of the product are used which differ as a function of the product type, with the result that different investments in machinery are required depending on whether tubes of lipstick or deodorant dispensers are to be manufactured.

Additionally, in the field of cosmetic product packaging in particular, there is an ongoing need to renew packaging, since the average lifespan of packaging, which can be extremely long in the case of bottles of perfume, may also be very brief in the case of dispensers of less prestigious products than perfumes, products typically that are considered in the present invention. Finally there is also an ongoing need to renew the packaged products, and to adapt the packaging as a consequence.

The invention intends to provide a solution to all of these problems.

### DESCRIPTION OF THE INVENTION

According to the invention, the dispenser for a product, typically a cosmetic product, such as a stick of lipstick intended to be applied to an application medium or surface such as the lips, includes a body with a tubular skirt forming a cavity for said product and equipped at its upper part with an upper aperture, a support for said product able to be displaced in an axial direction in said tubular skirt and thereby to make said product emerge through said upper aperture so that it can be used, a cap able to seal said upper aperture by engaging with said tubular skirt, and a means for axially displacing said support manually relative to said tubular skirt, and is characterised in that:

a) it includes a slider external to said tubular skirt, forming a closed annular slider or an open annular slider, able to be displaced manually in an axial run in said axial direction along said tubular skirt, said slider forming a so-called first part, said support forming or including a so-called second part, said first and second parts being attracted by radial magnetic forces, in such a way that said axial displacement of said slider causes that of said support and that thereby said product carried by said support is able to emerge as required through said upper aperture by a manual displacement of said outer slider,

b) the skirt of said body, said slider, and typically said support, have typically homothetical, noncircular, sections, namely outer S_{CE} and inner S_{CI} sections for the skirt of said body, outer S_{AE} and inner S_{AI} sections for said slider and an outer section S_{SE} for said support, the inner section S_{AI} of said slider (7, 7′, 7″) being at least equal to the outer section S_{CE} of the skirt (3) of said body (2), the outer section S_{SE} of said support (8) being at least equal to the inner section S_{CI} of the skirt (3) of said body (2), in such a way that said slider and said support are able to slide relative to the skirt of said body, and that said product, and typically said stick, is able to have a noncircular section S_{RE}, of form adapted to said application, said section S_{RE} being at least equal to said inner section S_{CI} of said skirt of said body.

The characteristic means of the present invention allow all of the problems posed to be resolved.

Indeed, on the one hand, the dispenser according to and an outer slider able to slide on the tubular skirt, a system of extreme simplicity if it is compared to those required in tubes of lipstick or in deodorant dispensers.

On the other hand, as will appear in the remainder of the description and in the figures, this propulsion system is adapted to different types of product, be it lipsticks, deodorants, or miscellaneous products in the form of creams, pastes, and more generally any fluid product possessing a certain rigidity at rest, in other words which does not flow in the absence of mechanical constraints applied to the product, the invention not relating to liquid products that are able to flow by themselves with no external constraint, products typically packaged in bottles closed with a bung.

Additionally, the dispenser according to the invention makes it possible to have products, typically new sticks of lipstick of potentially any section, a noncircular section S_{RE} of the stick being able to be very advantageous particularly in securing an accurate application of the stick to the lips.

Finally, dispensers according to the invention, apart from the fact that they constitute dispensers that are totally different from those of the prior art, may also promote a different mode of use, with the result that they constitute, for users, items which cannot be confused with those of the prior art.

### DESCRIPTION OF THE FIGURES

All the figures relate to dispensers or elements of dispensers according to the invention.

FIGS. 1a to 5a and FIG. 6f are axial cross-sections in a vertical plane passing through an axial direction of said dispenser.

The other figures are cross-sections in a horizontal plane perpendicular to the axial direction.

FIGS. 1a to 1f, 2 and 3a to 3c relate to one and the same mode of dispenser (1, 1′).

FIG. 1a shows the dispenser (1) closed.

FIG. 1b shows the body (2) of the dispenser (1) formed of a part cast in a single piece constituted by a tubular skirt (3) and a bottom (4, 4′).

FIG. 1c shows the cap (5) of the dispenser (1).

FIG. 1d shows the support (8) of the product (6, 6′) which includes a permanent magnet or a paramagnetic material (80).

FIG. 1e shows the annular slider (7, 7′), which includes a permanent magnet or a paramagnetic material (70), at least one of the two parts (7, 7′) and (8) including a permanent magnet.

FIG. 1f shows a packaged product (6), said product being a stick of lipstick (6′). Its transverse section has been shown in dotted lines, in an oval shape.

FIG. 2 shows the dispenser (1) of FIG. 1a open, the cap (5) having been separated from the body (2), and the annular slider (7, 7′) having been displaced upwards in order to make said stick emerge (6′).

FIG. 3a to 3c show enlarged views of different means of fastening (84) said product (6) to its support (8).

In FIG. 3a, the fastening means (84) includes a cup (840) able to hold the bottom of the stick (6′), said cup being anchored to the support (8) typically by an adhesive layer or a bond point (841), or possibly by being snapped on, the stick (6′) and the fastening means (84) forming a removable assembly (9′) able to form a refill for said dispenser.

In FIG. 3b, the support (8) includes a channel (842) able to hold the bottom of the stick (6′).

In FIG. 3c, the support (8) forms an axial projection or spike (843) able to hold the bottom of the stick (6′).

FIG. 4a shows another type of dispenser (1, 1″) wherein said support (8) forms a piston (8′), wherein said product (6) is a product of a cream type (6″), wherein said bottom (4) forms a part distinct (4″) from said tubular skirt (3) forming a fastening ring (41) acting as a stop for said slider (7, 7′) and said piston (8′), and wherein said skirt (3) includes at its upper part (30) a crown (34) including a plurality of orifices (340).

FIG. 4b relates to another type of dispenser (1, 1″), wherein said support (8) forms a piston (8′), said piston including a lower orifice sealed by a bung (83), so as to allow filling through the bottom, in which, as in FIG. 2, said bottom (4) forms a part distinct (4″) from said tubular skirt (3) forming a fastening ring (41) acting as a stop of the said slider (7) and said piston (8′), wherein said cap (5) forms a roundness and includes an inner sealing lip (52) for said product (6) which is typically in this case a stick of deodorant (6′″).

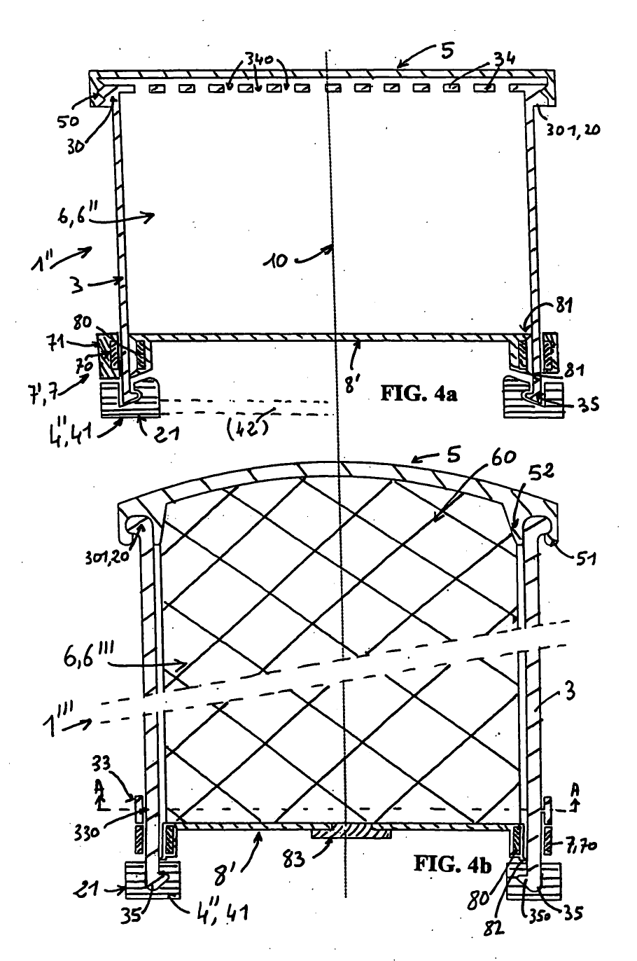

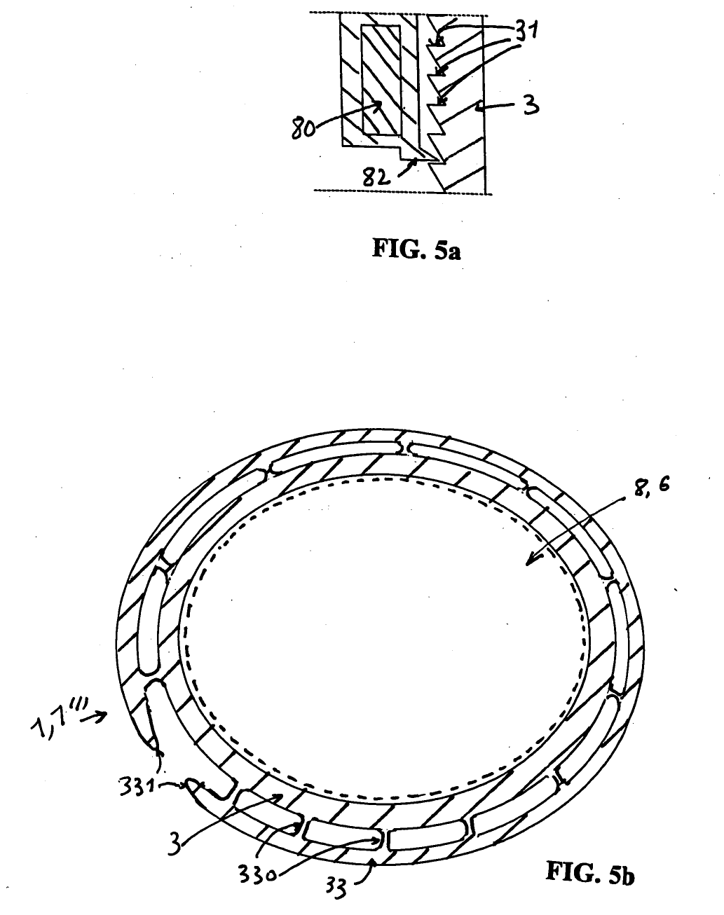

A shown in FIG. 5a which is a partial enlarged view of the engagement between a flexible edge (82) of the piston (8′) and a plurality of catches (31) formed on the inner surface of the skirt (3) in FIG. 4b, in such a way that any forward displacement of said piston is irreversible and that the emergent part (60) of the product (6′″) is able to sustain any axial pressure when the deodorant (6′″) is applied to the skin, with no risk of seeing the stick of deodorant being displaced towards the inside of said body as soon as the axial pressure is greater than the force resulting from the magnetic attraction between said slider (7, 7′) and said support (8).

As shown in FIG. 5b, which is a partial cross-section along the plane A-A of FIG. 4b, the dispenser (1, 1′″) includes a means (32) for the axial locking of the slider (7, 7′) before the first opening of the dispenser, so as to prevent any accidental displacement of the slider (7) and of the piston (8′). This locking means (32) includes a tab (33) fixed by a plurality of bridges (330) to said tubular skirt (3), the tab being placed so as to lock said slider against the lower stop (21), the tab (33) being open between two ends (331), so as to be able to be torn off manually during a first opening.

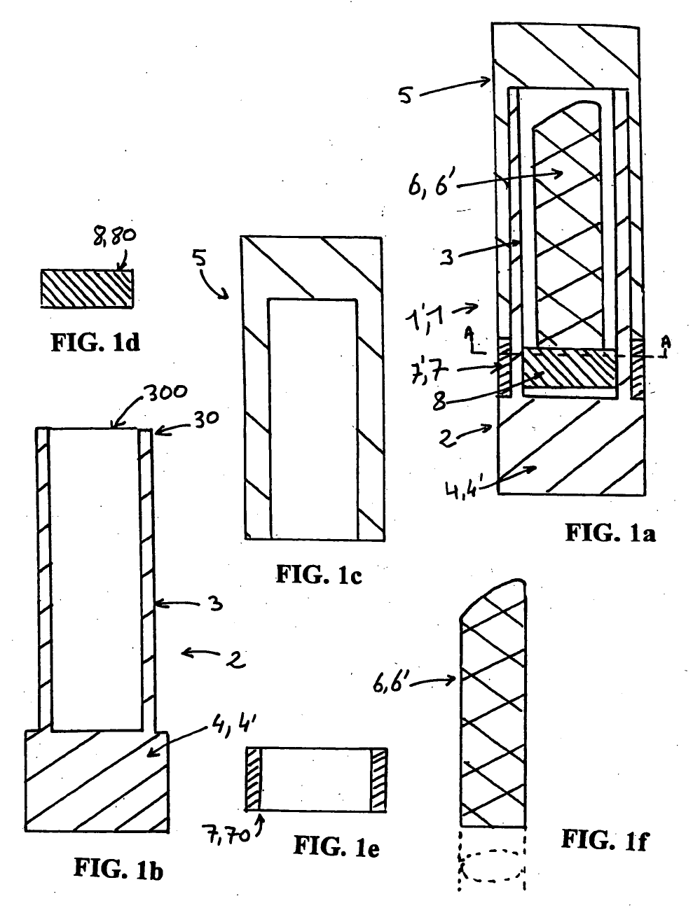

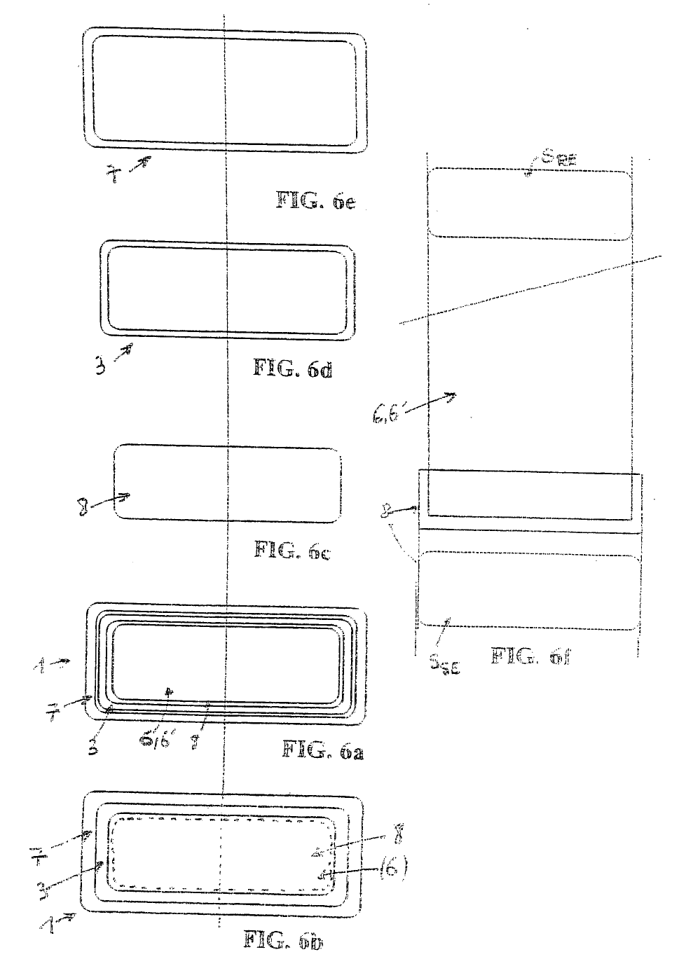

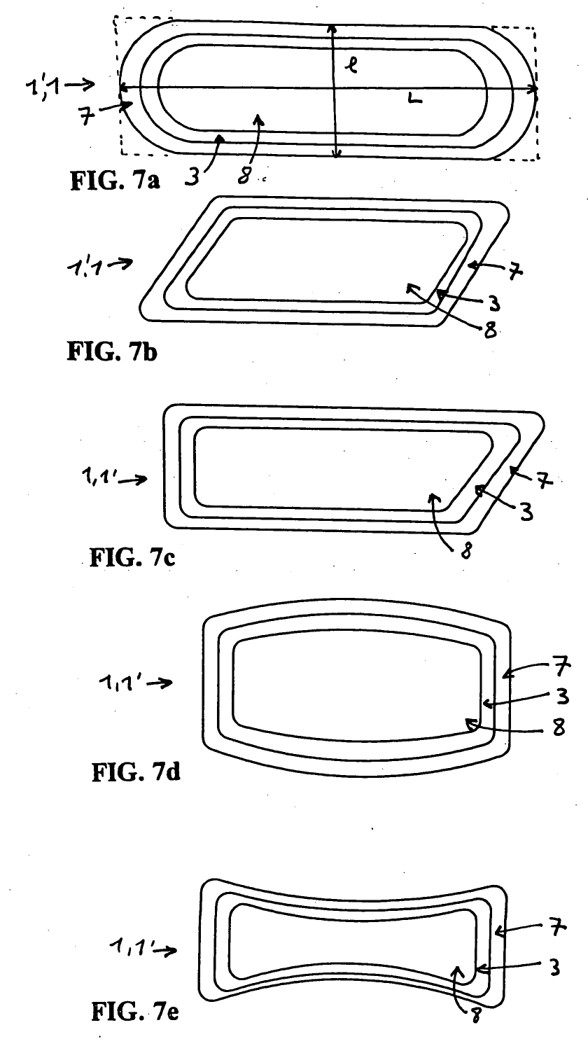

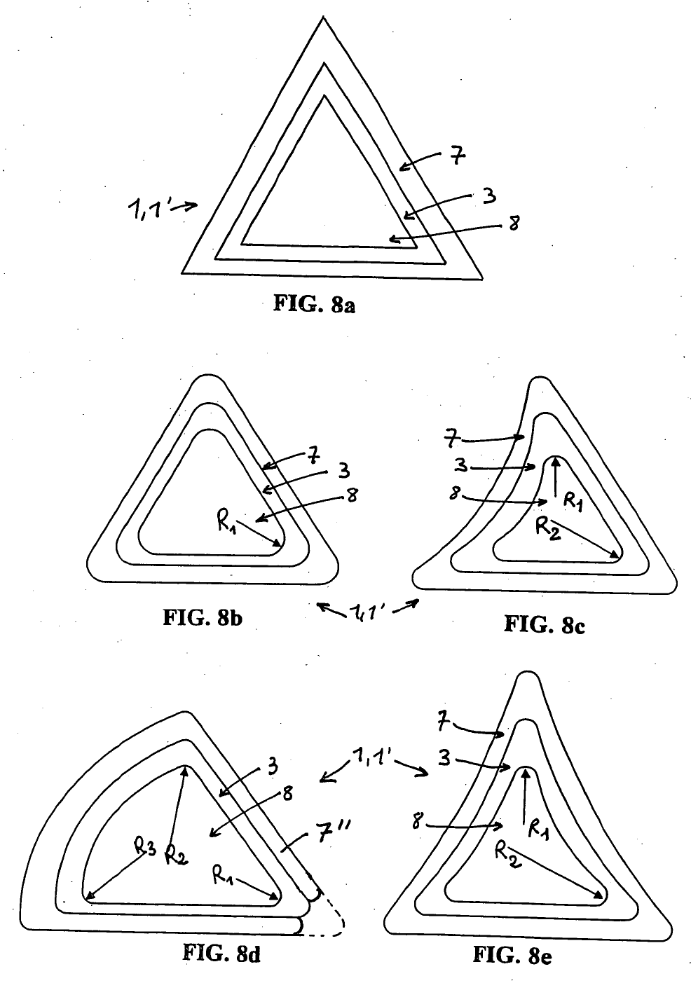

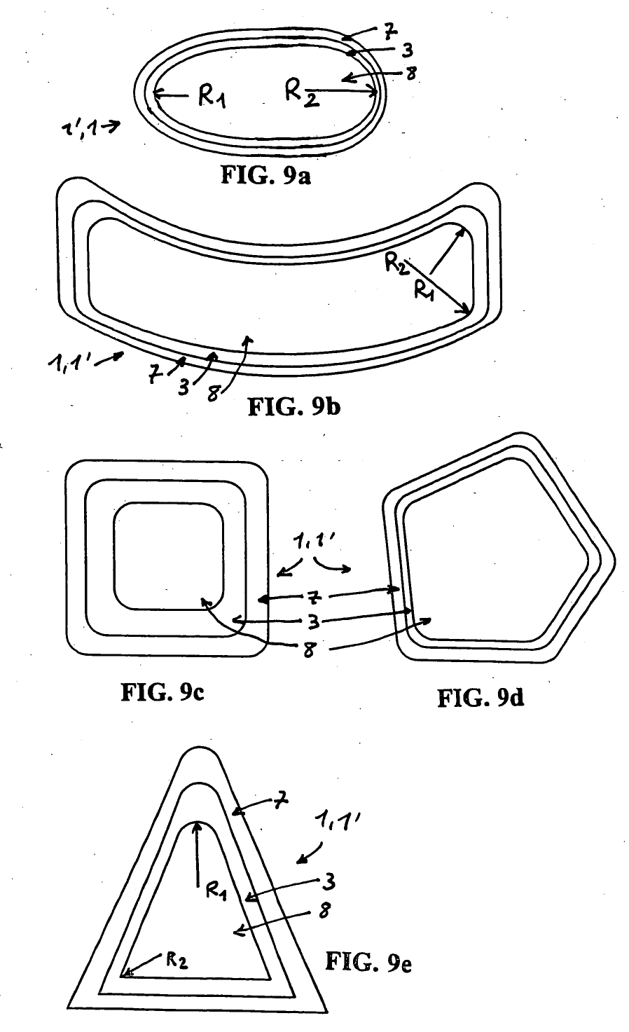

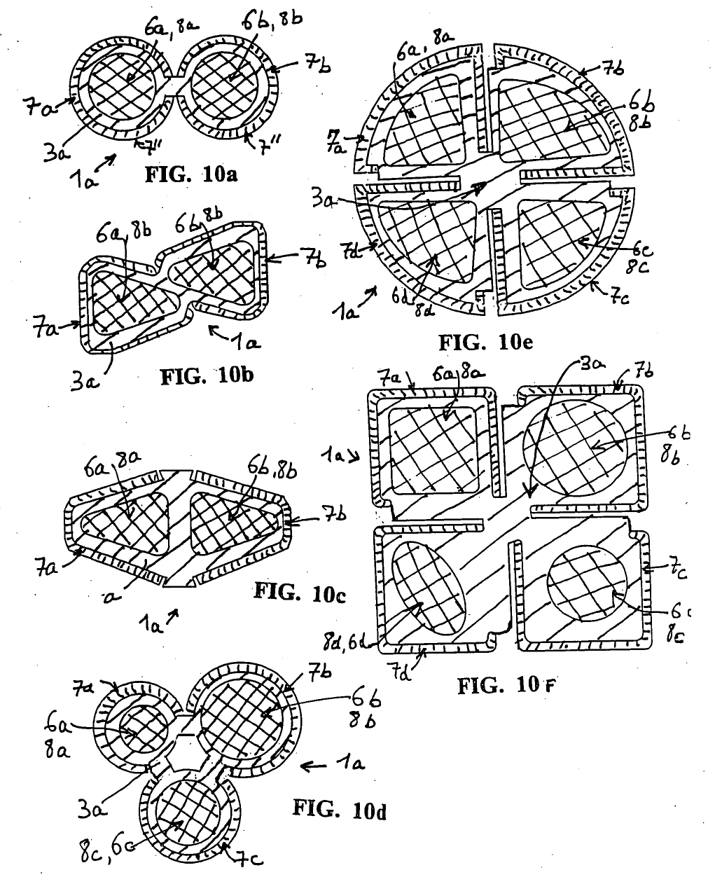

FIGS. 6a to 9e show—fully or in part—a cross-section in a horizontal plane A-A in FIG. 1a.

FIGS. 6a to 9e relate to a dispenser (1), which is typically a tube of lipstick (1′), but which may also be a rigid product or cream dispenser (1″), or else a stick-form deodorant dispenser (1′″).

FIGS. 6a to 6f relate to a dispenser (1, 1′, 1′″) of rectangular section. In FIG. 6a, the dispenser includes, from outside to inside: the annular slider (7, 7′) of outer section S_{AE} and inner section S_{AI}, the skirt (3) of the body (2) of outer section S_{CE} and inner section S_{CI}, and the support (8) of outer section S_{SE}, elements homothetical in form, with S_{AE}>S_{AI}>S_{CE}>S_{CI}>S_{SE}, in such a way that there is radial play, typically from 0.1 to 0.5 mm, between these three parts, and that the annular slider (7, 7′) is able to slide on said skirt (3) and is able to drive said support (8).

FIG. 6b is a simplified representation of FIG. 6a in which the radial play between the annular slider (7, 7′) and the radial play between the skirt (3) and between the skirt (3) and the support (8) are nil, as if we had S_{AE}=S_{CE} and S_{CI}=S_{SE}.

In this FIG. 6b, the stick (6, 6′) has been shown by a rectangle in dotted lines.

FIGS. 6c, 6d and 6e show respectively the three parts of the dispenser in FIGS. 6a and 6b, namely respectively: the support (8), the skirt (3) of the body (2), and the annular slider (7, 7′).

FIG. 6f is a view, in partial axial cross-section, of the support (8) and of the stick (6, 6′) fastened to the support. It includes, showed in dotted lines :

under the figure, the outer section S_{SE} of the support (8),

above the figure, the outer section S_{RE} of the stick (6, 6′).

FIG. 7a to 10f, similar to FIG. 6b, show different forms (sections) of the dispenser (1, 1′, 1″, 1′″) according to the invention.

FIG. 7a corresponds to homothetical sections (S_{AE}, S_{AE}, S_{CE}, S_{CI}, S_{SE}≅S_{RE}) corresponding to a rectangle with its ends rounded in a semicircle.

FIG. 7b corresponds to homothetical sections (S_{AE}, S_{AE}, S_{CE}, S_{CI}, S_{SE}≅S_{RE}) corresponding to a parallelogram.

FIG. 7c corresponds to homothetical sections (S_{AE}, S_{AE}, S_{CE}, S_{CI}, S_{SE}≅S_{RE}) corresponding to a trapezium.

FIG. 7d corresponds to homothetical sections (S_{AE}, S_{AE}, S_{CE}, S_{CI}, S_{SE}≅S_{RE}) corresponding to a rectangle the two larger sides of which are convex.

FIG. 7e corresponds to homothetical sections (S_{AE}, S_{AE}, S_{CE}, S_{CI}, S_{SE}≅S_{RE}) corresponding to a rectangle the two larger sides of which are concave.

FIGS. 8a to 8e correspond to sections of generally triangular shape.

FIG. 8a corresponds to homothetical sections (S_{AE}, S_{AE}, S_{CE}, S_{CI}, S_{SE}≅S_{RE}) corresponding to a triangle.

FIG. 8b corresponds to homothetical sections (S_{AE}, S_{AE}, S_{CE}, S_{CI}, S_{SE}≅S_{RE}) corresponding to a triangular shape with rounded apexes.

FIG. 8c corresponds to homothetical sections (S_{AE}, S_{AE}, S_{CE}, S_{CI}, S_{SE}≅S_{RE}) corresponding to a triangular shape one side of which is concave.

FIG. 8d corresponds to homothetical sections (S_{AE}, S_{AE}, S_{CE}, S_{CI}, S_{SE}≅S_{RE}) corresponding to an angular sector, or to a triangular shape one of the sides of which is convex.

In this figure an open annular slider (7″) has been shown, with a line in dots showing the corresponding closed annular slider (7′).

FIG. 8e corresponds to homothetical sections (S_{AE}, S_{AE}, S_{CE}, S_{CI}, S_{SE}≅S_{RE}) corresponding to a triangular shape two sides of which are concave.

In FIGS. 8c to 8e, as well as in FIGS. 9a, 9b, 9e, the support (8), and therefore the stick (6, 6′), has a section S_{SE} having radii of curvature R₁ to R₃ at least two of which are distinct, so as to be able to obtain a more or less fine line.

FIG. 9a corresponds to homothetical sections (S_{AE}, S_{AE}, S_{CE}, S_{CI}, S_{SE}≅S_{RE}) corresponding to an oval shape fitted with two different radii of curvature at its two ends.

FIG. 9b is a variant of FIGS. 7d and 7e.

FIG. 9c corresponds to homothetical sections (S_{AE}, S_{AE}, S_{CE}, S_{CI}, S_{SE}≅S_{RE}) corresponding to a square with rounded apexes.

FIG. 9d corresponds to homothetical sections (S_{AE}, S_{AE}, S_{CE}, S_{CI}, S_{SE}≅S_{RE}) corresponding to an irregular pentagon with rounded apexes, so as to have different radii of curvature at each apex of the pentagon.

FIG. 9e is a variant of FIGS. 8a and 8b.

FIGS. 10a to 10f, similar to FIG. 6b, show in transverse cross-section miscellaneous modes of multiple dispensers (1a) of N different sticks or products (6a) by their section, their colour shade or their composition:

FIG. 10a: 2 sticks circular in shape

FIG. 10b: 2 sticks triangular in shape

FIG. 10c: 2 sticks triangular in shape

FIG. 10d: 3 sticks circular in shape and of different diameter

FIG. 10e: 4 sticks approximately triangular in shape, said multiple dispenser (1a) being of circular section.

FIG. 10f: 4 sticks of different shapes, said multiple dispenser (1a) being of square section.

### DETAILED DESCRIPTION OF THE INVENTION

According to the invention, one (70, 80) of said first (70) and second (80) parts may include a permanent magnet, the other part (80, 70) including a permanent magnet, or a paramagnetic or ferromagnetic material of positive magnetic susceptibility typically greater than 1, so as to form said radial magnetic forces.

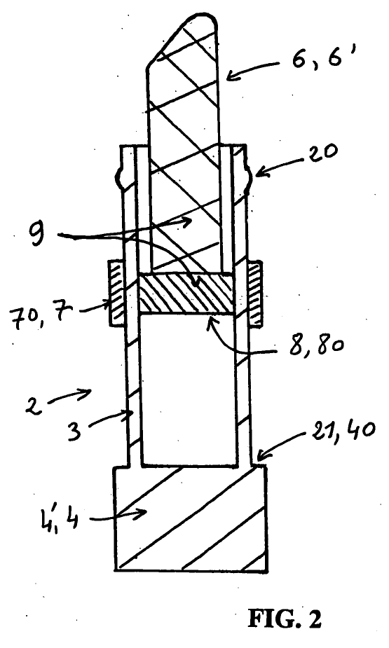

Typically, and as shown by way of example in FIG. 2, said body (2) or said tubular skirt (3) may include or form a so-called “upper” stop (20) and a so-called “lower” stop (21), so as to restrict said axial run of said slider (7, 7′, 7″) and to fix said slider (7, 7′, 7″) to said body (2). However, these stops must not prevent the assembly of the slider (7, 7′, 7″). Generally, one of these stops must allow the slider (7, 7′, 7″) to be forced past: this is the case of the upper stop (20) as far as the dispenser in FIG. 2 is concerned.

As shown in particular in FIGS. 1a, 1b and 2, said body (2) may include a bottom (4), said bottom (4) typically forming said lower stop (21) by means of a section or diameter greater than that of said skirt forming a shoulder (40) able to block said slider (7, 7′, 7″). As shown in these same figures, said bottom (4) can be a bottom (4′) forming with said skirt (3) a moulded part cast in a single piece.

However, said bottom (4) may be a bottom (4″) forming a part distinct from said skirt (3), said bottom (4″) and said skirt (3) being typically assembled by being snapped on or by bonding.

As shown in FIGS. 4a and 4b, said bottom (4″) may include or form a ring (41) for fixing to said skirt and possibly a central area (42), as shown partially—in dotted lines—in FIG. 4a. When the bottom includes a central area (42), it may then act as a lid or a means for sealing the bottom, after filling through the bottom.

As shown in FIGS. 4a and 4b, said support (8) may form a piston (8′) typically including a peripheral lip (81), in such a way that said piston (8′) engages in a typically sealed way with said tubular skirt (3).

The piston (8′) in FIG. 4a includes two sealing lips (81), the contact between the piston (8′) and the inner wall of the tubular skirt (3) being made by these two parallel peripheral lips.

However, said part (80) may itself form said piston, in particular when it is not necessary for said part (80) to slide in a sealed way in said tubular skirt (3).

According to the invention, said axial displacement may be reversible, said slider (7, 7′, 7″) being therefore able to come against said lower stop (21), and possibly to be held against said lower stop (21), particularly when said upper aperture (300) is sealed by said cap (5). In this case, the slider (7, 7′, 7″) may take up any position between the stops (20, 21), once the cap (5) is removed.

According to one advantageous embodiment shown in FIG. 1a, said cap (5), said slider (7, 7′) and said bottom (4, 4′, 4″) may have one and the same axial cross-section, said cap (5) having sufficient height for said dispenser (1) to have a uniform section over its entire height when it is closed, said cap (5) sealing said upper aperture (300).

In this case, said slider, which can always resume the same position when the dispenser (1) is closed, may form a decorative element of the dispenser (1).

According to the invention, and as shown in FIGS. 4b and 5a, said axial displacement may be irreversible, typically through an engagement between a plurality of catches (31) formed on the inner surface of said tubular skirt (3) and a flexible edge (82) of said support (8), said catches (31) being orientated so as to allow only a so-called upwards axial displacement corresponding to the emergence of said product (6) through said orifice (300), in such a way particularly that said application of said product is able to bring into play an axial resistance generated by said radial magnetic forces. In this case, the position of the slider (7, 7′, 7″) along the tubular skirt (3) is an indicator of level, which reliably conveys the height of product remaining in the body (2) of the dispenser.

As shown in FIGS. 4a and 4b, said upper part (30) of said tubular skirt (3) may include or form an outer projection (301), said outer projection (301) typically forming said upper stop (20) and providing said engagement with said cap, by screwing or being snapped on.

In FIG. 4a, this outer projection (301) is threaded, and allows the cap (5) to be screwed on.

In FIG. 4b, this outer projection (301) allows the cap (5) to be snapped on.

As shown in FIGS. 4b and 5b, said tubular skirt (3) may include a means (32) for the axial blocking of said slider (7, 7′, 7″) against said lower stop (21) prior to a first opening of said dispenser (1), said axial blocking means (32) forming a means of detecting said first opening, and typically including a tab (33) connected to said tubular skirt (3) by a plurality of bridges (330) able to be broken by pulling manually on one end (331) of said tab (33) during said first opening.

As shown in particular 6a to 9e, said body (2), said slider (7, 7′, 7″), and said support (8, 8′) may have homothetical noncircular sections, said product (6, 6′, 6″, 6′″), typically said stick (6′), having a noncircular section S_{RE} close to or homothetical with that S_{SE} of said support (8).

According to a variant shown in FIG. 4a, said tubular skirt (3) can be blocked at its upper part by a crown (34) including a plurality of orifices (340), said product (6) typically being a pasty or creamy product able to flow through said orifices (340). In this variant, the dispenser can be filled through the bottom. In this case, it may be advantageous to fix using bridges the fixing ring (41) and the piston (8′), so as to seal the bottom, after filling, by a single axial snap-on action allowing the piston (8′) and the ring (41) to be assembled to the skirt (3) simultaneously.

But, as shown in FIG. 4b, said support (8, 8′) may include a filling orifice sealed with a bung (83), so as to be able to fill said dispenser (1) with product (6) through its lower part.

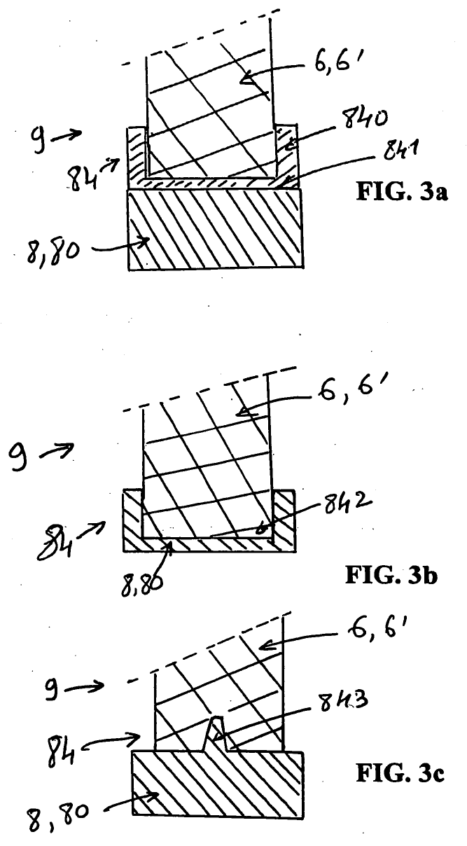

As shown in FIG. 3c, said support (8) may include a means for fastening or anchoring (84) said product (6), typically in the form of an axial projection (843) penetrating into said product (6). This is the case particularly when said product is in stick form, of sufficient consistency for an axial projection (843) to be able to form an anchoring means. Typically, the product is moulded onto the support and axial projection (843) thereof.

As shown in all the figures except FIG. 8d, said slider (7) may form a closed annular slider (7′), said part (70) typically being coated in a sheath of plastic material (71), as shown in FIG. 4a, so as to avoid direct contact of said metal part against the outer wall of said tubular skirt (3), and thereby any risk of abrasion.

Although only FIG. 8d shows the case of a dispenser including an open annular slider (7″), it goes without saying that generally, given the curvature of said slider (7), it is by no means mandatory for said slider (7) to form a closed annular slider (7′) to remain integral with the tubular skirt (3) of said body (2).

FIGS. 10a to 10f show the case of double to quadruple dispensers including a number of open annular sliders (7″).

According to the invention, and as shown in FIGS. 6a to 9e, said noncircular sections may be homothetical sections with a form selected from among the following forms including line segments or arc portions: triangular, square, rectangular, trapezoidal, polygonal, oval, oblong, angular sector.

The inner section S_{CI}, of the skirt of said body and the corresponding outer section S_{PE} of said product S_{PE} may have one and the same form factor L/1 typically between 1 and 5, L and 1 being the largest dimension and the smallest dimension respectively of the smallest rectangle, or of the smallest square if L=1, into which said section may fall. See FIG. 7a.

This form factor is slightly greater than 3 in the case of FIG. 7a and is equal to 1 in the case of FIG. 9c.

As shown in FIG. 7d, 7e, 8c, 8d, 8e and 9b, all or part of said line segments of the different forms and sections may be inwardly curved concave line segments or outwardly curved convex line segments.

According to the invention, said dispenser may have an H/D ratio of typically between 0.8 and 10, H and D being the largest axial or height dimension and the largest radial or diameter dimension respectively of said closed dispenser.

According to one embodiment of the invention, said H/D ratio may be greater than 3, said dispenser (1) may form a tube of lipstick (1′), said product (6) then being typically a stick of lipstick (6′).

Typically, said product or said stick being relatively solid in terms of their consistency, said stick (6′) and said support (8) may form a removable assembly (9), said assembly forming a refill, so as to be able to change said assembly either to change the colour shade of the stick, or when said stick has been fully used up. See for example FIG. 3b.

However, as shown in FIG. 3a, said stick (6′) and said anchoring means (84) of said support (8) may form a removable assembly (9′), said assembly (9′) forming a refill, so as to be able to change said assembly either to change the colour shade of the stick, or when said stick has been fully used up.

According to another embodiment of the invention, said H/D ratio may be between 2 and 4, said dispenser (1) forming a stick-form deodorant dispenser and said product (6) typically being a deodorant stick (6′″).

According to another embodiment of the invention, said H/D ratio may be less than 4, said dispenser (1) then forming a cream dispenser and said product (6) typically being a rigid product such as a cream (6″).

Another object of the invention is constituted by a multiple dispenser (1a) of a plurality of N products (6), typically cosmetic products, including a body (2) with a multi-tubular skirt (3a) forming a plurality of N cavities for said plurality of N products (6), said cavities being equipped at their upper part (30a) with upper apertures (300a), a plurality of N independent supports (8a) for said N products (6a) able to be displaced in an axial direction of said multi-tubular skirt (3a) and thus to make said products (6a) emerge through said upper apertures (300a) so that they can be used and typically applied to an application surface, a cap (5) or a plurality of caps (5a) able to seal said upper apertures (300), and a means to ensure manually an axial displacement of each of said supports (8a) relative to said multi-tubular skirt (3a), in which a plurality of N independent sliders (7a) external to said multi-tubular skirt (3) forming a plurality of N open rings, each open ring surrounding a support, said open rings being able to be displaced manually in an axial run in said axial direction along said multi-tubular skirt (3a), each of said sliders (7a) forming a part (70), said support (8a) forming or including another part (80), said parts (70) and (80) being attracted by radial magnetic forces, in such a way that each axial displacement of one of the N independent sliders (7a) drives that of said corresponding support (8a) and that thereby said corresponding product (6a) carried by said support (8a) is able to emerge as required through said corresponding upper aperture (300a).

Multiple dispensers of this kind (1a) are shown in FIGS. 10a to 10f.

N is equal to 2 for the dispensers in FIGS. 10a to 10c.

N is equal to 3 for the dispenser in FIG. 10d.

N is equal to 4 for the dispensers in FIGS. 10e and 10f.

In each of the cases, the manual displacement of each of the sliders (7a, 7b, 7c, 7d) causes the displacement of the corresponding support (8a, 8b, 8c, 8d), and therefore the emergence of the corresponding product (6a, 6b, 6c, 6d). In FIGS. 10a to 10f, said supports and said products have been shown and merged with one and the same section.

In this multiple dispenser (1a), N may be between 2 and 6 and said plurality of products (6a) may correspond to a plurality of transverse section perpendicular to said axial direction, and/or a plurality of colour shades, and/or a plurality of products that are distinct through their chemical composition.

Another purpose of the invention is constituted by the use of the dispenser (1) according to the invention or of the multiple dispenser (1a) to form a tube or a dispenser of lipstick (1′), as shown in FIG. 2 or in FIGS. 6a to 9e, or as shown in FIGS. 10a to 10f.

Another purpose of the invention is constituted by the use of the dispenser (1) according to the invention to form a dispenser (1″) of a fluid and rigid product, typically a cream, as shown in FIG. 4a.

Another purpose of the invention is constituted by the use of the dispenser (1) according to the invention to form a dispenser or applicator (1′″) of deodorant in stick form, as shown in FIG. 4b.

In this case, and as shown in FIG. 4b, the stick does not generally adhere to the inner wall of the tubular skirt (3), because of the shrinking caused when the liquid product introduced into the cavity solidifies, which reduces accordingly the frictional forces to be overcome in order to ensure said axial displacement.

### Embodiment Examples

The figures constitute embodiment examples of dispensers (1) according to the invention.

To manufacture the dispenser (1, 1′) according to FIGS. 1a to 2, a magnetised pellet was used to form said support (8) and said part (80), said pellet being 15 mm in diameter and 3 mm high, and, as the annular slider (7′) forming said second part (70), an iron ring with an inner diameter of 18 mm, an outer diameter of 21 mm, i.e. 1.5 mm thick, and 5 mm high, which corresponds to a gap of 1.5 mm.

The other parts of the dispenser (1, 1′) were manufactured by plastic material moulding.

An axial force of 3.3 N was thus obtained, a force greater than the frictional resistance of the assembly (9) formed by said support (8) and said product (6, 6′), namely a stick of lipstick.

In the assembly (9) in FIG. 2, the stick was fixed to the magnetised pellet (80) using the surface roughness of the pellet, or in some cases via a bond point.

FIGS. 3a to 3c show other implementation variants in respect of fixing the stick to its support and forming said assembly (9).

A dispenser (1, 1″) was also manufactured in accordance with FIG. 4a, a dispenser for a rigid and not very viscous cosmetic product such as a care or makeup cream (6″).

A dispenser was also manufactured similar to the one shown in FIG. 4a, but with a crown (34) and an arc-shaped cap (5) as in FIG. 4b.

A dispenser was also manufactured similar to the one in FIG. 4a, wherein the fixing ring (4″, 41) engages with the piston (8′) and with the annular slider (7′), so as to form a assembly (4 ″+7′+8′) that can be easily handled, an assembly anchored to the lower part (35) of the tubular skirt (3) by being snapped on axially after said product (6, 6″) has been loaded into the cavity formed by said tubular skirt (3) closed by said cap (5) and in the upturned position.

A dispenser (1, 1′″) was also manufactured in accordance with FIGS. 4b to 5b, a dispenser of a product in stick form (6′″), typically a deodorant. The deodorant was introduced as a liquid through an orifice of the piston (8′), the dispenser (1′″) being in the upturned position, said orifice being then sealed with the bung (83) or with an adhesive label.

In the case of dispensers (1″) and (1′″) in FIGS. 4a and 4b, two annular coaxial parts were used as first and second parts (70) and (80), of section S_{A} and S_{S} adapted to the section S_{C} of the skirt of said body, one (70) as a permanent magnet and the other (80) of iron, both 2 mm thick, and 8 and 6 mm high respectively, with a gap of 2 mm, the inner diameter D for the first part (70) forming the outer annular slider (7, 7′) being 40 mm.

An axial force was thereby obtained of the order of about 14 N, a force which is amply sufficient to displace the products (6″) and (6′″) axially.

The second annular part (80) was overmoulded with the piston (8′), and likewise, the first annular part (70) of the dispenser (1″) in FIG. 4a was overmoulded with its plastic sheath (71).

In the case of the dispensers (1″) and (1′″), the lower end (35) of the tubular skirt (3) includes an inner radial projection (350) with an orientated profile selected so as to allow said piston (8) equipped with said second part (80) to pass forcibly—in the axial direction (10)—and the fastening ring (41) to be snapped on.

In the case of the dispenser (1′″) in FIGS. 4b to 5b, the tubular skirt (3) was moulded with a tab or guarantee seal (33) connected by bridges (330) to the skirt (3). This embodiment constitutes additionally a means of axially blocking said slider (7), a first opening detection means.

Dispensers (1, 1) were also manufactured in accordance with FIGS. 6a to 9e, which give detail on the sections of the lipstick dispensers in FIGS. 1a to 3c.

Said slider (7) is a closed annular slider (7′) except in the case in FIG. 8d where said slider is an open annular slider (7″).

Multiple dispensers (1a) were also manufactured in accordance with FIGS. 10a to 10f. To this end, the multi-tubular skirt (3a), fitted with N axial cavities, was formed by moulding. The sliders (7a) were put in place and, in each cavity, the support (8a) and the corresponding stick (6a) were put in place.

Said support (8, 8a) includes said part (80) laterally fixed to a cup (840) into which said stick is driven (6, 6′, 6a).

The skirt (3, 3a) of the body (2) of the dispenser may include an upper stop (20) for said lateral slider (7a, 7″), a stop which has been shown in FIG. 2.

According to one embodiment variant, and whatever the embodiment example, it may be advantageous for said slider (7, 7′, 7″, 7a) to engage with the outer surface of said tubular skirt with a level of frictional force that is sufficient to be able to apply the stick to the lips without having to hold the slider manually at a set position, to ensure sufficient emergence of the stick outside the body (2).

Conversely, with a weak frictional force, it would be necessary to hold the slider manually at its axial position when applying the stick to the lips, or more generally said product to the face or to the skin.

### ADVANTAGES OF THE INVENTION

The invention has great advantages.

Indeed, on the one hand it allows dispensers to be manufactured with a limited number of parts, and, on the other hand, it allows these parts to be assembled by a straightforward axial assembly, which is highly advantageous economically.

Additionally, it has been found that a slight spring effect is produced when applying said product (6), which is not the case with prior art dispensers, which enhances the flexibility of the application of said product and constitutes a very favourable element for the user. This spring effect is due to the magnetic coupling between the slider (7) presumed anchored during said application and the support (8), which is axially free.

Even when the axial displacement of the slider (7) is irreversible, as shown in FIG. 5a, the flexible edge (82) may be selected so as to retain this spring effect.

Moreover, the invention offers the possibility of having products, in particular sticks of lipstick of potentially any type of form or section, one and the same stick having in particular different radii of curvature, which may be highly valued in getting in particular different stroke or flat tint effects, and this is the case either with a number of dispensers (1) or with a multiple dispenser (1a).

In this way, the invention meets the latent desire of any user to be able to have a stick in forms other than the straightforward cylindrical form.

Finally, the invention leads both to a new way of operating and using said dispenser, and to a new presentation of these dispensers, such that the dispensers according to the invention have a strong power of identification, and therefore a strong power of “discrimination” relative to prior art dispensers, which is more often than not in great demand in terms of packaging and marketing cosmetic products or beauty care products.

### LIST OF REFERENCE NUMBERS

| | |
|---|---|
| Dispenser | 1 |
| Multiple Dispenser | 1a |
| Dispenser forming a tube of lipstick | 1′ |
| Dispenser of rigid product, of cream | 1″ |
| Dispenser of deodorant in stick form | 1′′′ |
| Axial direction | 10 |
| Body of 1 | 2 |
| Upper stop of 7 | 20 |
| Lower stop of 7 | 21 |
| Tubular skirt of 2 | 3 |
| Multi-tubular skirt | 3a |
| Upper part | 30 |
| Upper aperture | 300 |
| Outer projection | 301 |
| Catches | 31 |
| Means for the axial blocking of 7 | 32 |
| Tab | 33 |
| Connection bridges between 33 and 3 | 330 |
| End | 331 |
| Crown | 34 |
| Orifices | 340 |
| Lower part | 35 |
| Inner projection | 350 |
| Bottom of 2 | 4 |
| Bottom as part cast in one piece with 3 | 4′ |
| Bottom as part distinct from 3 | 4″ |
| Shoulder | 40 |
| Ring for fixing to 3 | 41 |
| Central area | 42 |
| Part that can be snapped onto 51 | 43 |
| Cap of 1 | 5 |
| Threaded part engaging with 300 | 50 |
| Part for snapping onto 300 - hook | 51 |
| Inner sealing lip | 52 |
| Product | 6 |
| Multiple products | 6a, 6b, 6c, 6d |
| Stick of lipstick | 6′ |
| Cream type rigid product | 6″ |
| Stick of deodorant | 6′′′ |
| Emergent Part | 60 |
| Slider | 7 |
| Open slider for multi-tubular skirt | 7a, 7b, 7c, 7d |
| Closed annular slider | 7′ |
| Open annular slider | 7″ |
| First part | 70 |
| Support for 6, 6′, 6″, 6′′′ | 8 |
| Piston | 8′ |
| Second Part | 80 |
| Peripheral lip | 81 |
| Flexible edge | 82 |
| Bung | 83 |
| Fastening means | 84 |
| Cup | 840 |
| Adhesive layer | 841 |
| Channel | 842 |
| Axial projection | 843 |
| Removable “product(6) + support(8)” | 9 |
| assembly = refill | |
| Removable “product(6) + fastening | 9′ |
| means 84” assembly | |

1. Dispenser (1) for a product (6), typically a cosmetic product, such as a stick of lipstick intended to be applied to an application medium or surface such as the lips, including a body (2) with a tubular skirt (3) forming a cavity for said product (6) and equipped at its upper part (30) with an upper aperture (300), a support (8) for said product (6) able to be displaced in an axial direction in said tubular skirt (3) and thereby to make said product (6) emerge through said upper aperture (300) so that it can be used, a cap (5) able to seal said upper aperture (300) by engaging with said tubular skirt (3), and a means for axially displacing said support (8) manually relative to said tubular skirt (3), characterised in that:
a) it includes a slider (7) external to said tubular skirt (3), forming a closed annular slider (7′) or an open annular slider (7″), able to be displaced manually in an axial run in said axial direction along said tubular skirt (3), said slider (7, 7′, 7″) forming a so-called first part (70), said support (8) forming or including a so-called second part (80), said first and second parts (70, 80) being attracted by radial magnetic forces, in such a way that said axial displacement of said slider (7, 7′, 7″) causes that of said support (8) and that thereby said product (6) carried by said support (8) is able to emerge as required through said upper aperture (300) by a manual displacement of said outer slider,
b) the skirt (3) of said body (2), said slider (7, 7′, 7″), and typically said support, have typically homothetical, noncircular, sections, namely outer S_{CE} and inner S_{CI} sections for the skirt (3) of said body (2), outer S_{AE} and inner S_{AI} sections for said slider (7, 7′, 7″) and an outer section S_{SE} for said support (8), the inner section S_{AI} of said slider (7, 7′, 7″) being at least equal to the outer section S_{CE} of the skirt (3) of said body (2), the outer section S_{SE} of said support (8) being at least equal to the inner section S_{CI} of the skirt (3) of said body (2), in such a way that said slider (7, 7′, 7″) and said support (8) are able to slide relative to the skirt (3) of said body (2), and that said product (6, 6′, 6″, 6′″), and typically said stick (6′), is able to have a noncircular section S_{RE}, of form adapted to said application, said section S_{RE} being at least equal to said inner section S_{CI} of said skirt (3) of said body (2).

2. Dispenser according to claim 1 wherein one (70, 80) of said first (70) and second (80) parts includes a permanent magnet, the other part (80, 70) including a permanent magnet, or a paramagnetic or ferromagnetic material of positive magnetic susceptibility typically greater than 1, so as to form said radial magnetic forces.

3. Dispenser according to claim 1, wherein said body (2) or said tubular skirt (3) include or form a so-called “upper” stop (20) and a so-called “lower” stop (21), so as to restrict said axial run of said slider (7, 7′, 7″) and to fix said slider (7, 7′, 7″) to said body (2).

4. Dispenser according to claim 1, wherein said body (2) includes a bottom (4), said bottom (4) typically forming said lower stop (21) by means of a section or diameter greater than that of said skirt forming a shoulder (40) able to block said slider (7, 7′, 7″).

5. Dispenser according to claim 4 wherein said bottom (4) is a bottom (4′) forming with said skirt (3) a moulded part cast in a single piece.

6. Dispenser according to claim 4 wherein said bottom (4) is a bottom (4″) forming a part distinct from said skirt (3), said bottom (4″) and said skirt (3) being typically assembled by being snapped on or by bonding.

7. Dispenser according to claim 6 wherein said bottom (4″) includes or forms a ring (41) for fixing to said skirt and possibly a central area (42).

8. Dispenser according to claim 1, wherein said support (8) forms a piston (8′) typically including a peripheral lip (81), in such a way that said piston (8′) engages in a typically sealed way with said tubular skirt (3).

9. Dispenser according to claim 1, wherein said axial displacement is reversible, and wherein said slider (7, 7′, 7″) is therefore able to come against said lower stop (21), and possibly to be held against said lower stop (21), particularly when said upper aperture (300) is sealed by said cap (5).

10. Dispenser according to claim 9 wherein said cap (5), said slider (7, 7′, 7″) and said bottom (4, 4′, 4″) have one and the same axial section, and wherein said cap (5) has sufficient height for said dispenser (1) to have a uniform section over its entire height when it is closed, said cap (5) sealing said upper aperture (300).

11. Dispenser according to claim 1, wherein said axial displacement is irreversible, typically through an engagement between a plurality of catches (31) formed on the inner surface of said tubular skirt (3) and a flexible edge (82) of said support (8), said catches (31) being orientated so as to allow only a so-called upwards axial displacement corresponding to the emergence of said product (6) through said orifice (300), in such a way particularly that said application of said product is able to bring into play an axial force greater than the axial resistance generated by said radial magnetic forces.

12. Dispenser according to claim 1, wherein said upper part (30) of said tubular skirt (3) includes or forms an outer projection (301), said outer projection (301) typically forming said upper stop (20) and providing said engagement with said cap, by screwing or being snapped on.

13. Dispenser according to claim 12 wherein said tubular skirt (3) includes a means (32) for the axial blocking of said slider (7, 7′, 7″) against said lower stop (21) prior to a first opening of said dispenser (1), said axial blocking means (32) forming a means of detecting said first opening, and typically including a tab (33) connected to said tubular skirt (3) by a plurality of bridges (330) able to be broken by pulling manually on one end (331) of said tab (33) during said first opening.

14. Dispenser according to claim 1, wherein said body (2), said slider (7, 7′, 7″), and said support (8, 8′) have homothetical noncircular sections, said product (6, 6′, 6″, 6′″), typically said stick (6′), having a noncircular section S_{RE} close to or homothetical with that S_{SE} of said support (8).

15. Dispenser according to claim 1, wherein said tubular skirt (3) is blocked at its upper part by a crown (34) including a plurality of orifices (340), said product (6) typically being a pasty or creamy product able to flow through said orifices (340).

16. Dispenser according to claim 1, wherein said support (8, 8′) includes a filling orifice sealed with a bung (83), so as to be able to fill said dispenser (1) with product (6) through its lower part.

17. Dispenser according to claim 1, wherein said support (8) includes a means for fastening or anchoring (84) said product (6), typically in the form of an axial projection (843) penetrating into said product (6).

18. Dispenser according to claim 1, wherein said slider (7) forms a closed annular slider (7′), said part (70) typically being coated in a sheath of plastic material (71).

19. Dispenser according to claim 1, wherein said noncircular sections are homothetical sections with a form selected from among the following forms including line segments or arc portions: triangular, square, rectangular, trapezoidal, polygonal, oval, oblong, angular sector.

20. Dispenser according to claim 1, wherein the inner section S_{CI} of the skirt of said body and the corresponding outer section S_{PE} of said product S_{PE} have one and the same form factor L/1 typically between 1 and 5, L and 1 being the largest dimension and the smallest dimension respectively of the smallest rectangle, or of the smallest square if L=1, into which said section may fall.

21. Dispenser according to claim 19, wherein all or part of said line segments are inwardly curved concave line segments or outwardly curved convex line segments.

22. Dispenser according to claim 1, with an H/D ratio of typically between 0.8 and 10, H and D being the largest axial or height dimension and the largest radial or diameter dimension respectively of said closed dispenser.

23. Dispenser according to claim 22 wherein said H/D ratio is greater than 3, said dispenser (1) forming a tube of lipstick (1′) and said product (6) then being typically a stick of lipstick (6′).

24. Dispenser according to claim 23 wherein said stick (6′) and said support (8) form a removable assembly (9), said assembly forming a refill, so as to be able to change said assembly either to change the colour shade of the stick, or when said stick has been fully used up.

25. Dispenser according to claim 23 wherein said stick (6′) and said anchoring means (84) of said support (8) form a removable assembly (9′), said assembly (9′) forming a refill, so as to be able to change said assembly either to change the colour shade of the stick, or when said stick has been fully used up.

26. Dispenser according to claim 22 wherein said H/D ratio is between 2 and 4, said dispenser (1) forming a stick-form deodorant dispenser and said product (6) typically being a deodorant stick (6′″).

27. Dispenser according to claim 22 wherein said H/D ratio is less than 4, said dispenser (1) then forming a cream dispenser and said product (6) typically being a rigid product such as a cream (6″).

28. Multiple dispenser (1a) of a plurality of N products (6), typically cosmetic products, including a body (2) with a multi-tubular skirt (3a) forming a plurality of N cavities for said plurality of N products (6), said cavities being equipped at their upper part (30a) with upper apertures (300a), a plurality of N independent supports (8a) for said N products (6a) able to be displaced in an axial direction of said multi-tubular skirt (3a) and thus to make said products (6a) emerge through said upper apertures (300a) so that they can be used and typically applied to an application surface, a cap (5) or a plurality of caps (5a) able to seal said upper apertures (300), and a means to ensure manually an axial displacement of each of said supports (8a) relative to said multi-tubular skirt (3a), in which a plurality of N independent sliders (7a) external to said multi-tubular skirt (3) forming a plurality of N open rings, each open ring surrounding a support, said open rings being able to be displaced manually in an axial run in said axial direction along said multi-tubular skirt (3a), each of said sliders (7a) forming a part (70), said support (8) forming or including another part (80), said parts (70) and (80) being attracted by radial magnetic forces, in such a way that each axial displacement of one of the N independent sliders (7a) drives that of said corresponding support (8a) and that thereby said corresponding product (6a) carried by said support (8a) is able to emerge as required through said corresponding upper aperture (300a).

29. Multiple dispenser according to claim 28 wherein N is a figure from 2 to 6.

30. Dispenser according to claim 28, wherein said plurality of products (6a) corresponds to a plurality of transverse section perpendicular to said axial direction, and/or a plurality of colour shades, and/or a plurality of products that are distinct through their chemical composition.

31-32. (canceled)
